(19) United States
(12) Patent Application Publication
(10) Pub. No.: US 2010/0237236 A1
(43) Pub. Date: Sep. 23, 2010

(54) Method Of Processing Multiple Precursor Ions In A Tandem Mass Spectrometer

(75) Inventors: Bruce Thomson, Toronto (CA); Bruce Collings, Bradford (CA)

Correspondence Address: RAUSCHENBACH PATENT LAW GROUP, LLP, P.O. BOX 387, BEDFORD, MA, 01730, US

(73) Assignees: Applera Corporation, Framingham, MA (US); MDS, Inc., Concord (CA)

(21) Appl. No.: 12/408,026

(22) Filed: Mar. 20, 2009

(51) Int. Cl. B01D 59/44

(52) U.S. Cl. 250/283

(57) ABSTRACT

A method of processing multiple precursor ions in a tandem mass spectrometer includes generating a plurality of precursor ions with an ion source. At least some of the plurality of precursor ions is trapped in an ion trap. At least two precursor ions of interest are isolated from the plurality of precursor ions with a filtered noise field. Precursor ions of interest are sequentially ejected toward a collision cell. The sequentially ejected precursor ions of interest are fragmented in a collision cell. The mass-to-charge ratio spectra of the fragmented ions are then determined with a mass spectrometer.

The section headings used herein are for organizational purposes only and should not to be construed as limiting the subject matter described in the present application in any way.

### INTRODUCTION

Tandem mass spectrometers, which are sometimes referred to as (MSMS or MS-MS instruments) are mass spectrometers that have more than one mass analyzer. The mass analyzers do not necessarily have to be of the same type of mass analyzer. There are various tandem mass spectrometer geometries. For example, there are tandem mass spectrometers with quadrupole-quadrupole, magnetic sector-quadrupole, quadrupole-linear-ion-trap, and quadrupole-time-of-flight mass spectrometer geometries. Tandem mass spectrometers are capable of multiple rounds of mass spectrometry, which are usually separated by some form of molecule fragmentation or reaction. The multiple rounds of mass spectrometry enable researchers to perform a wide variety of structural and sequencing studies of molecules.

### BRIEF DESCRIPTION OF THE DRAWINGS

The present teachings, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the invention. The drawings are not intended to limit the scope of the applicant's teachings in any way.

FIG. 1 illustrates a tandem mass spectrometer that includes an ion trap that isolates ions of interest with a filtered noise field and that performs multiplexed measurements according to the present teachings.

FIG. 2 illustrates a tandem mass spectrometer that includes two ion traps that isolate ions of interest with a filtered noise field and that performs multiplexed measurements according to the present teachings.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

It should be understood that the individual steps of the methods of the present teachings may be performed in any order and/or simultaneously as long as the invention remains operable. Furthermore, it should be understood that the apparatus and methods of the present teachings can include any number or all of the described embodiments as long as the invention remains operable.

The present teachings will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teachings herein will recognize additional implementations, modifications, and embodiments, as well as other fields of use, which are within the scope of the present disclosure as described herein.

In conventional tandem mass spectrometers, each precursor ion from the ion source is sequentially selected for MSMS. While the MSMS spectrum of one precursor ion is being obtained, other precursor ions are wasted because they cannot be processed in parallel. Sequential processing of the mixture of precursor ions is inefficient and sample materials are wasted. In numerous mass spectrometry applications where the concentration of the components is very low, some components may be missed completely because there is not enough time to obtain MSMS spectra on every component.

Ion traps are used in many time-of-flight (TOF) mass spectrometers to improve the sample efficiency. Time-of-flight mass spectrometers with ion traps can perform multiplexed measurements. Mass selective ion traps, such as linear ion traps (LIT), can trap ions generated by the ion source and selectively eject ions from the ion trap into a collision cell and then into a mass spectrometer, such as an orthogonal injection TOF mass spectrometer. The ion traps allow the researcher to measure the mass-to-charge ratio of substantially all or a high fraction of the ions generated by the ion source.

In some mass spectrometer systems and modes of operating some mass spectrometer systems, the ion traps can trap a relatively large density of ions and, therefore, a relatively high level of space charge can be present in the ion trap. When there are too many ions in the ion trap, the electric field within the ion trap becomes distorted. The relatively high space charge in the ion trap makes the mass selective ejection from the ion trap inefficient. In addition, the relatively high space charge in the ion trap reduces the ion selectivity of the ion trap.

One method of addressing the problems associated with a relatively high level of space charge is to establish a filtered noise field (FNF) in the ion trap that isolates the ions of interest so that they experience a significantly reduced level of space charge. For example, if there are several ions of interest with different mass-to-charge ratio values, a FNF can be applied in the ion trap to isolate a mass window around each of the mass-to-charge ratio values of interest, thereby eliminating all ions that are not of interest, and leaving only those ions of interest within the ion trap. However, when a very high level of space charge is present in the ion trap it can be difficult to effectively employ the FNF to isolate ions of interest.

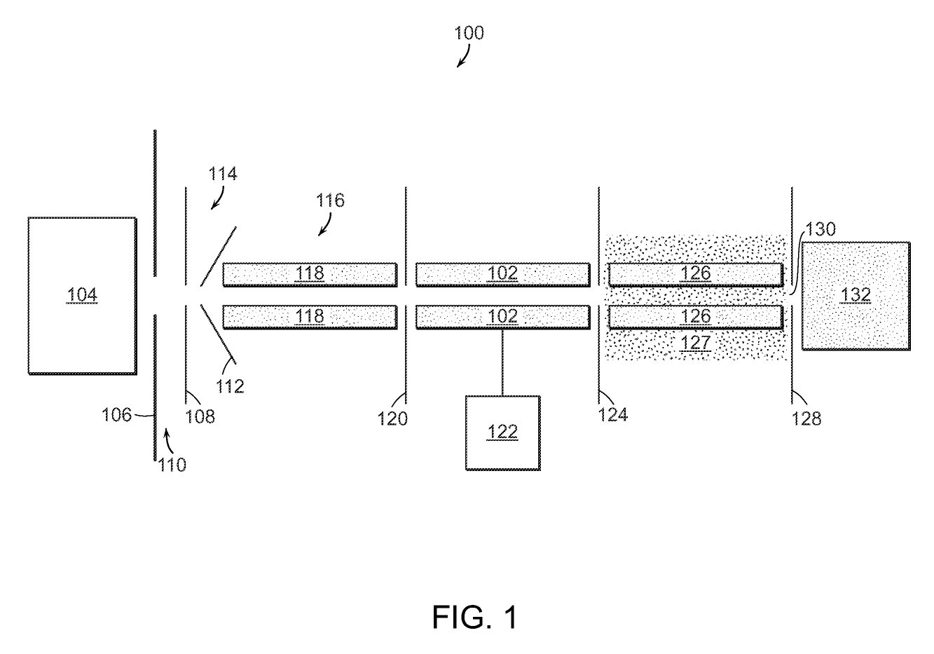

FIG. 1 illustrates a tandem mass spectrometer 100 that includes an ion trap 102 that isolates ions of interest with a filtered noise field and that performs multiplexed measurements according to the present teachings. The tandem mass spectrometer 100 includes an ion source 104 that generates ions which are directed towards a curtain plate 106. Numerous types of ion sources, such as electrospray ion sources, can be used. An orifice plate 108 is positioned adjacent to the curtain place 106 to form a curtain chamber 110 between the orifice plate 108 and the curtain place 106 that can contain a curtain gas which reduces the flow of unwanted neutrals into the analyzing sections of the mass spectrometer 100.

A skimmer plate 112 is positioned adjacent to the orifice plate 108. An intermediate pressure chamber 114 is formed between the orifice plate 108 and the skimmer plate 112. The skimmer plate 112 is designed so that ions pass through the skimmer plate 112 and into the first chamber 116 of the tandem mass spectrometer 100. The first chamber 116 includes an ion guide Q0 118 that collects and focuses the ions passing through the skimmer plate 112 and directs the ions to the analyzing sections of the mass spectrometer. A first interquad barrier or lens IQ1 120 is positioned to separate the first chamber 116 from the ion trap 102. The lens IQ1 120 has an aperture for passing ions.

An ion trap 102 is positioned with an input that is adjacent to the first lens IQ1 120. An output of a waveform generator 122 is coupled to the ion trap 102. The waveform generator 122 generates a filtered noise field that is used to isolate ions of interest in the ion trap 102 as described herein. A second interquad barrier or lens IQ2 124 is positioned at the output end of the ion trap 102.

A collision cell 126 that contains a collision gas 127 is positioned with an input that is adjacent to the second lens IQ2 124. A third interquad barrier or lens IQ3 128 is positioned at the output end of the collision cell 126 so that it can be maintained at a relatively high pressure once the collision gas 127 enters the collision cell 126. This pressure is analyte dependent and can be on order of 5 mTorr for some analytes. The product ions generated by the collision cell 126 pass through lens Q3 128 to an exit 130.

A mass spectrometer 132 is positioned with an input that receives the product ions generate by the collision cell 126. Numerous types of mass spectrometers 132 can be used. For example, the mass spectrometer 132 can be a QTrap linear ion trap, a quadrupole mass filter or an orthogonal TOF mass spectrometer. An orthogonal TOF mass spectrometer has high mass resolution and high mass accuracy, but inherently suffers from limited efficiency due to duty cycle losses of the orthogonal geometry. Methods of improving the duty cycle have been disclosed in U.S. Pat. Nos. 6,285,027 and 6,507,019, which are assigned to the present assignee. These methods may be used to improve the duty cycle of an orthogonal TOF mass spectrometer to achieve maximum sample efficiency and ion utilization.

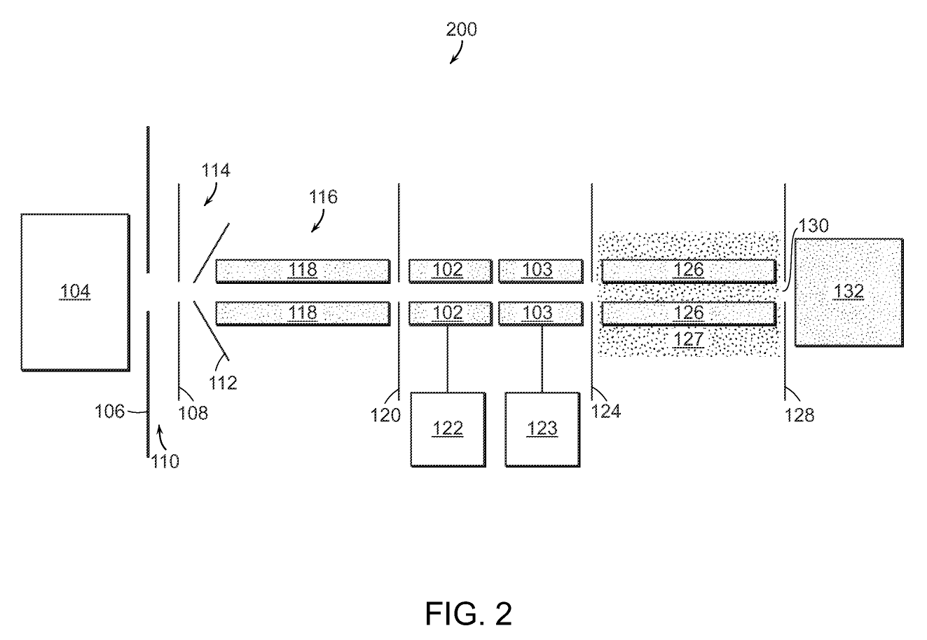

FIG. 2 illustrates a tandem mass spectrometer 200 that includes two ion traps that isolate ions of interest with a filtered noise field and that performs multiplexed measurements according to the present teachings. The tandem mass spectrometer 200 is similar to the tandem mass spectrometer 100 that was described in connection with FIG. 1. However, the tandem mass spectrometer 200 includes the first 102 and a second ion trap 103 positioned in series. The output of the waveform generator 122 is coupled to the ion trap 102 and the output of the waveform generator 123 is coupled to the ion trap 103. Each of the first 102 and the second ion trap 103 can be operated as separate ion traps. The waveform generator 122 generates a filtered noise field that is used to isolate ions of interest in the ion trap 102; and the waveform generator 123 generates a filtered noise field that is used to isolate ions of interest in the ion trap 103 as described herein.

It should be understood by those skilled in the art that the representation of FIGS. 1 and 2 are schematic, and various additional elements would be necessary to complete a functional apparatus. For example, a variety of power supplies are required for delivering AC and DC voltages to different elements of the tandem mass spectrometers 100, 200. In addition, a vacuum pumping arrangement is required to maintain the operating pressures of the various chambers of the tandem mass spectrometer at the desired operating levels.

Many mass spectrometry applications require the identification of multiple components in a complex mixture. Tandem mass spectrometry is often the most suitable method of providing identification of each compound in a complex mixture. In many applications, the components of the mixture are not fully separated by liquid chromatography and, therefore, multiple components are present as a mixture in the ion source 104. A mass spectrum may contain many peaks corresponding to these multiple components.

The tandem mass spectrometers described in connection with FIGS. 1 and 2 are high efficiency mass spectrometers that can provide MSMS spectra for multiple components in complex samples. There are numerous modes of operation and methods of using these tandem mass spectrometers to process and characterize multiple precursor ions. Depending upon the application, the ion trap 102 can be operated as a mass filter for normal MSMS operation without multiplexing, or it can be operated as an ion trap with a filtered noise field that provides isolation of precursor ions of interest. Depending upon the mode of operation, the tandem mass spectrometers described in connection with FIGS. 1 and 2 can be operated with high efficiency and high selectivity even in the presence of a high level of space charge as described herein.

In various methods according to the present teachings, the ion source 104 generates a mixture of ions, which typically consist of many precursor ions. The mixture of ions is directed towards the curtain plate 106 and the adjacent orifice plate 108. A curtain gas can be flowed into the curtain chamber 110 to reduce the flow of unwanted neutrals into the analyzing sections of the mass spectrometer. In some modes of operation, the pressure in the intermediate pressure chamber 114 between the orifice plate 108 and the skimmer plate 112 is on order of about 2 Torr. The mixture of ions passes through the skimmer plate 112 and into the first chamber 116 of the mass spectrometer 100.

The ion guide Q0 118 collects and focuses the ions passing through the skimmer plate 112 and directs the ions to the analyzing sections of the mass spectrometer 100. In various modes of operation, the precursor ions from the ion source 104 can be trapped or retained in the Q0 ion guide 118 while the batch of precursor ions is being processed. That is, the mixture of ions can be trapped in the ion guide Q0 118 while the ions are processed in the ion traps 102 and/or 103. This increases the overall duty cycle of the methods and preserves the precursor ions so that no precursor ions of interest are wasted.

A first interquad barrier or lens IQ1 120 passes ions from the first chamber 116 to the ion trap 102. In some methods, a mass spectrum measurement is taken to identify all the precursor ions before isolating precursor ions of interest with the filtered noise field.

The waveform generator 122 generates a filtered noise field signal with multiple notches that is applied to the ion trap 102. The ion trap 102 traps or isolates at least two precursor ions of interest from the plurality of precursor ions. In some methods, the precursor ions of interest are cooled by collision in the ion trap 102 for a period of a few milliseconds. Desired precursor ions are then axially ejected from the ion trap 102 towards and into the collision cell 126 for fragmentation.

The present invention contemplates various modes of trapping or isolating the precursor ions of interest. In one mode of operation, it is desired to trap precursor ions of interest and then to obtain a product ion spectrum of each of the precursor ions (or some desired subset of the product ion spectrum), without wasting any ions. This mode of operation is highly efficient and is useful when only small samples are available.

In another mode of trapping or isolating the precursor ions of interest, a portion of the precursor ions are selected by filtering and then only the selected precursor ions are transmitted into the collision cell 126 for fragmentation. In this mode of trapping, the quadrupole ion trap 102 is used as a mass filter and the ions are trapped in ion trap 103. For example, the quadrupole mass filter 102 can be operated at low resolution to transmit a relatively wide mass range to the ion trap 103 where the ions are trapped. The mass filter 102 substantially reduces the space charge in ion trap 103 by eliminating all ions that are not within the mass range of interest. For example, a mass range of 350 to 450 amu could be transmitted by quadrupole mass filter 102 into ion trap 103. The precursor ions of interest that are within the transmitted mass range are then sequentially ejected from ion trap 103 toward the collision cell 126 according to their mass-to-charge ratio. The term “sequentially ejected” as used herein means that ions are ejected over a period of time rather than all at once or instantaneously. The present teachings contemplate numerous types of sequences. For example, in one method, after one precursor ion is ejected from the ion trap 102 and through the collision cell 126 for fragmentation, a second precursor ion is ejected from the ion trap 102 into the collision cell 126. Each targeted precursor ion in sequence is ejected for fragmentation until all of the selected precursor ions have been processed.

The mass-to-charge ratio values of the precursor ions may be non-contiguous. For example, m/z 382 could be ejected first. Then m/z 403 could be ejected. Then m/z 422 could be ejected. Alternatively, the ions of interest could be ejected without regard to the order of their m/z value. Using this example, the ions of interest could be ejected in the order of m/z 403, then 382, then 422. This can be achieved by changing the frequency of the dipolar excitation and/or the q-value of the ion of interest by changing the RF frequency or the RF amplitude. In various methods described here, sequential ejection of ions of interest can be done from ion trap 102 or ion trap 103 by applying appropriate voltages and waveforms from waveform generators 122 or 123 respectively.

The precursor ions can be ejected by any one of several methods. For example, the precursor ions can be ejected by resonance excitation, which is well known in the art. With resonance excitation, ions of different mass-to-charge ratio values in an RF quadrupole are first trapped together with a fixed RF voltage on the electrodes. Ions of a particular mass-to-charge ratio value or range of mass-to-charge values are excited by applying a dipolar excitation between two opposite rods, or by applying a quadrupolar AC excitation voltage on all four rods.

The radial excitation is applied at a frequency that corresponds to the secular frequency of oscillation of the ion of interest, which causes ions of the selected mass-to-charge value to be ejected axially over a DC barrier that is applied at the exit from the ion trap 102. In some methods, precursor ions are trapped in an axial harmonic DC well, with radial confining fields. Selective ejection of a particular mass-to-charge value can be achieved by exciting the motion of the precursor ions in an axial direction at a frequency that is resonant with the oscillation frequency of the ion of interest. Excitation can eject the ions over a barrier near the exit from the ion trap 102.

The collision cell 126 fragments the sequentially ejected precursor ions of interest into product ions. In various methods, the product ions can be trapped in the collision cell 126 for further processing, or can be transmitted toward a second mass spectrometer. The mass spectrometer 132 records the mass spectrum of the product ions, or of a selected targeted product ion.

The mass-to-charge ratio spectra of the product ions can then be determined with the mass spectrometer 132. The present teachings contemplate numerous types of mass spectrometers, such as a time-of-flight mass spectrometer, a quadrupole mass spectrometer, an ion trap mass spectrometer, an orbitrap mass spectrometer, and an FTMS mass spectrometer. In addition, the present teaching contemplates numerous types of reaction monitoring, such as selected reaction monitoring (SRM) or multiple reaction monitoring (MRM), which are common methods using to perform spectrometric quantitation.

In practice, the presence of a large number of ions results in a high level of space charge that modifies the electric fields inside the ion trap 102 in such a way that the ion frequency of motion is a function of the amount of the space charge in the ion trap 102. The efficiency and selectivity of the mass selection can be significantly reduced because the resonant frequencies of the ions change with the number of ions in the ion trap. Various methods of the present teachings overcome the effects of a high level of space charge in the ion trap 102 by ejecting unwanted ions that contribute to the space charge in the ion trap 102. In these methods, unwanted ions are radially ejected from the ion trap 102 so that they are lost on the rods of the ion trap 102. The amount of space charge is reduced when the unwanted ions are ejected and, consequently, the excitation frequency of the ions of interest can be more accurately predicted.

The present teachings include several methods for efficiently isolating ions in the presence of relatively high space charge in the ion trap 102 to improve the sensitivity and the dynamic range of tandem mass spectrometers with high ion currents. One method of eliminating a large number of unwanted ions in the ion trap 102 is to apply a waveform with a broad range of excitation frequencies to the ion trap 102, with notches in the broad frequency range that correspond to the frequencies of the precursor ions of interest. Such a waveform is referred to in the art as a filtered noise field (FNF) waveform. The FNF waveform is chosen so that unwanted ions are excited radially until they are lost to the rods of the ion trap, while the ions of interest are not excited.

In some modes of operation where the space charge in the ion trap is at a relatively high level, applying a FNF waveform will not be effective in eliminating the unwanted ions and retaining the ions of interest. This ineffectiveness occurs when the level of space charge is high enough that the resonant frequencies of the ions of interest change significantly from their predicted resonant frequency. In this situation, the notches in the FNF waveform do not align well with the resonant frequencies of the precursor ions of interest. Therefore, the frequencies of the precursor ions of interest shift to regions in the FNF waveform where there are no notches, and consequently these ions of interest are ejected from the ion trap 102. The present teachings include several methods for overcoming these problems with high space charge to provide good selectivity in isolating the ions of interest. The methods can be used for isolating precursor ions prior to MSMS, or for isolating ions of interest that have already been processed by MSMS or other means prior to performing other processing, such as MS^{nth} or ion reactions

In one such method, the waveform generator 122 generates a FNF waveform with a wide or coarse isolation window and then applies the signal to the ion trap 102 for a short period of time. Applying such a FNF waveform will reduce the space charge significantly and also leave the precursor ions of interest in the ion trap 102, along with other ions with mass-to-charge ratio values that lie in a window around the mass-to-charge ratio values of each of the ions of interest. In some methods, the waveform generator 122 then generates a FNF waveform that includes progressively finer notches in finer and finer steps that further reduce the number of unwanted ions. Thus, the FNF waveform effectively narrows the isolation window around each of the ions of interest, and therefore, the space charge effects experienced by the ions of interest.

In another method, a FNF waveform is generated with relatively wide notches that exclude a wide range of mass-to-charge ratio values centered around each of the desired ions of interest. Including wide notches ensure that even if the resonant frequency of the desired precursor ions is shifted by the presence of space charge, the resonant frequency still remains within the width of the wide notch. Such a FNF waveform with wide notches results in ejection of significant numbers of unwanted ions in regions of the waveform spectrum where there are no precursor ions of interest and, therefore, can significantly reduce the space charge.

After the FNF waveform with the wide notches is applied for a long enough period of time to eject a substantial number of unwanted ions, a second FNF waveform with narrower notches is applied. The second FNF waveform further reduces the space charge by eliminating unwanted ions with mass-to-charge ratios that are close to the mass-to-charge ratios of the ions of interest.

The process of applying narrower and narrower notches to more selectively retain only the precursor ions of interest is continued until the space charge in the ion trap 102 is reduced to below a certain threshold or target level. Then, the specific precursor ions are sequentially ejected from the ion trap 102 into the collision cell 126. The product ions generated in the collision cell 126 are then passed to the mass spectrometer 132 for MSMS analysis.

After applying the FNF waveform to the ion trap 102 in progressive steps as described above, substantially only the precursor ions of interest remain in the ion trap 102 for further processing. Most other ions are substantially ejected from the ion trap 102. The precursor ions of interest can lie at several widely different mass-to-charge ratio values. The ejection of the unwanted ions results in a much smaller population of ions in the ion trap and, therefore, much less space charge in the ion trap. Consequently, the ejection of the unwanted ions causes the excitation frequencies of the precursor ions of interest to be considerably more predicable and, thus the ions of interest can be more selectively ejected from the ion trap toward the collision cell 102.

Another method that efficiently isolates ions in the presence of relatively high space charge or ion current traps the ions in the first ion trap 102, and then slowly transfers the precursor ions over time into the ion trap 103 while the waveform generator 123 is applying a filtered noise field to ion trap 103. The slow transfer of precursor ions reduces the space charge in the ion trap 103 as it is being filled, compared to other methods where all of the ions are trapped together in ion trap 103 before applying the FNF. In this method, the ions in the ion trap 103 experience reduced space charge effects because the number of ions in the ion trap 103 can be greatly reduced during isolation.

Yet another method that efficiently isolates ions in the presence of relatively high space charge in the ion trap 102 traps all of the ions in ion trap 102, and then transfers them in a step-wise fashion to ion trap 103, where the precursor ions of interest are isolated with a FNF waveform. Isolation of a small fraction of the ions in ion trap 103 can be accomplished with reduced space charge effect. After isolation of the first fraction of the ions in ion trap 103, the second fraction of the ions in ion trap 102 can be transferred to ion trap 103, and then the FNF can be re-applied to isolate the precursor ions of interest. This process can be repeated until substantially all ions are isolated in ion trap 103. In this process, the ions in the ion trap 103 experience reduced space charge effects during the isolation steps because the number of ions in the ion trap 103 can be greatly reduced during isolation.

In yet another method of generating FNF waveforms according to the present teachings that is effective in the presence of high space charge, all the precursor ions from the ion source 104 are initially trapped in the collision cell 126 downstream from the ion trap 102. A portion of the precursor ions trapped in the collision cell 126 are then transferred from the collision cell 126 back into the ion trap 102. A FNF waveform is then applied to ion trap 102 to isolate the precursor ions of interest. In this method, a small enough portion of the trapped ions can be transferred back into the ion trap 102 to reduce the amount of space charge in the ion trap 102 to a low enough level to obtain efficient isolation of the precursor ions of interest.

At some time after applying the FNF waveform, another portion of the precursor ions trapped in the collision cell 126 are transferred from the collision cell 126 back into the ion trap 102. The FNF waveform is then applied again to the ion trap 102. This process can be repeated until substantially all the ions have been transferred back to the ion trap 102 and isolated. The step-wise method allows the FNF waveform to be effectively used in the presence of a larger number of ions and the associated higher level of space charge, by gradual isolation of the precursor ions of interest. For example, in one specific method, approximately 10% of the ions are transferred in each step. The amount of ions transferred can be controlled by lowering the voltage on the lens IQ2 124 for a brief period of time before increasing it. The length of time for which the voltage is lowered can control the number of ions that are transferred. In practice, the time period of the transfer step can be gradually increased as the ions in the ion trap 102 are depleted. It may be useful to apply an axial electric field within the collision cell 126 to assist in controlling the ion flow toward ion trap 102. For example, the axial field may be directed toward the lens IQ2 124 that acts as a barrier so that ions are close to the barrier when the voltage is lowered.

Another method of generating FNF waveforms according to the present teachings that is effective in the presence of high space charge initially traps all the ions from the ion source in the collision cell 126 downstream from the ion trap 102. A FNF waveform is applied continuously to the ion trap 102 while precursor ions are slowly but continuously transferred from the collision cell 126 back into the ion trap 102. The stepwise transfer of ions from the collision cell 126 into the ion trap 102 can be accomplished by gradually lowering the voltage on the lens IQ2 124 that acts as a potential barrier between the collision cell 126 and the ion trap 102. The barrier can be gradually ramped downward to allow more and more ions to diffuse into the ion trap 102. The rate at which the potential barrier is lowered can control the rate at which ions are transferred into the ion trap 102. By making the process gradual, while applying FNF to the ion trap 102, the number of ions in ion trap 102 can be controlled so that the space charge is maintained at a low value, sufficient to allow effective isolation of the precursor ions of interest. For example, the voltage on lens IQ2 124 can be linearly reduced over a period of 100 ms from a value at which no ions can be transferred down to a value at which all ions will be transferred. Because some ions are more energetic than others, the more energetic or thermally hotter ions will cross the barrier and be transferred first as the voltage is lowered, and the less energetic ions will be transferred later in the ramp. In some cases the voltage ramp applied to lens IQ2 124 may be non-linear in time.

Once the precursor ions are completely transferred and isolated in the ion trap 102, they are sequentially ejected into the collision cell 126 for fragmentation. An axial electric field in the collision cell 126 can be used to push the ions toward the exit 130. Each MSMS spectrum measurement of a selected precursor ion may require only 10-20 ms. Total acquisition times can be relatively short. For example, if the step of filling the ion trap 102 takes about 10 ms, and the gradual isolation step takes about 100 ms, then it is estimated that 10 MSMS spectra can be acquired in a total time of about 210 to 310 ms.

Another method of generating FNF waveforms according to the present teachings that is effective in the presence of high space charge applies the FNF waveform to the ion trap 102 while precursor ions are flowing through the ion trap 102 and are being trapped (without fragmentation) in the collision cell 126. In this method, ions are not trapped in the ion trap 102. The typical transit time of the precursor ions through the ion trap 102 is less than about 1 ms. This flow-through mode of operation provides only coarse isolation of the precursor ions of interest. However, the flow-through mode of operation removes a significant number of the unwanted precursor ions before they reach collision cell 126. Therefore, the number of unwanted precursor ions that are trapped in collision cell 126 is significantly reduced.

Once the collision cell 126 is filled to the extent desired, ions are then transferred back into the ion trap 102 while precursor ions from the ion source 104 are trapped upstream in the ion guide Q0 118. The precursor ions trapped in ion trap 102 can be further processed to isolate all target precursor ions for MSMS by applying a FNF waveform to the ion trap 102 again over a longer period of time. In addition, the mixture of precursor ions can also be processed by sequentially ejecting the precursor ions of interest into the collision cell 126 for fragmentation.

Tandem mass spectrometers according to the present teachings that include two ion traps, such as the tandem mass spectrometer 200 described in connection with FIG. 2, can achieve additional modes of operation that reduce the effects of space charge. For example, tandem mass spectrometers with two ion traps can provide isolation of precursor ions of interest by a two-step axial ejection process. Ions are first trapped in ion trap 102. Then excitation waveforms of moderately high amplitude are applied to ion trap 102 at frequencies corresponding to those of the precursor ion of interest. For example, if there are 10 precursor ions of interest, then ten different excitation frequencies can be applied to ion trap 102 using dipolar or quadrupole excitation as is known in the art. If the excitation amplitudes are relatively high, then a relatively wide range of ion mass-to-charge ratio values around each target value will be excited and transferred over the barrier lens IQ2 into ion trap 103. Even if space charge has shifted the frequency of an ion of interest, it can be transferred into ion trap 103 if a relatively wide mass range around each target mass-to-charge ratio value is transferred.

For example, if a target ion mass-to-charge ratio value is m/z 432, and a high space charge exists in ion trap 102, then the secular frequency of m/z 432 may actually lie at a frequency that corresponds to an ion of m/z 425. However, if a moderately high amplitude excitation is applied, then ions of m/z between values of 420 and 450 may be transferred, including the ion of interest at m/z 425. This provides a rapid and coarse transfer of a range of ions from ion trap 102 to ion trap 103. Multiple high amplitude waveforms can be applied to transfer of the ions of interest from ion trap 102 into 103 with coarse resolution, so that all precursor ions of interest are trapped in ion trap 103, along with many other ions of different mass-to-charge ratio values. However, many ions will still remain in ion trap 102, and can be eliminated by a high amplitude FNF without any notches or by other methods. The ions remaining in ion trap 103 will have less space charge than when they were in ion trap 102.

The FNF methods as described herein can be further used to isolate the individual precursor ions of interest in ion trap 103. The ions of interest can be sequentially ejected into collision cell 126. Alternatively, after transferring the ions from ion trap 102 into ion trap 103, the space charge may be reduced to a value low enough that the frequencies are not affected by space charge. The ions of interest can then be ejected sequentially from ion trap 103 without applying a FNF to further isolate the ions.

In some modes of operation, there is no need to reduce the quantity of space charge in the ion trap 102. For example, the intensity of the ions generated by the ion source 104 may be low enough so that the space charge does not affect the transfer process. In these modes of operation, it is not necessary to use FNF waveforms to isolate precursor ions. Substantially all ions can be trapped in the ion trap 102 and allowed to cool for a few milliseconds. The precursor ions of interest can then be sequentially transferred to the collision cell 126 for fragmentation and then transferred to the mass spectrometer 132 for measurement. This allows high-efficiency processing of all precursor ions of interest, especially if ions are retained in the ion guide Q0 118 while the precursor ions are processed in the ion trap 102 and in the collision cell 126.

In various modes of operating the tandem mass spectrometer according to the present teachings, MSMS spectra can be obtained for some or all of the precursor ions generated by the ion source. For example, in one mode of operation, all the ions are trapped in the ion trap 102 and then precursor ions are sequentially ejected in sequence according to their mass-to-charge ratio. In one specific mode of operation, precursor ions are ejected starting from the lowest mass-to-charge ratio value and proceeding to the highest mass-to-charge ratio value. In this mode of operation, MSMS measurements can be obtained for all precursor ions in one experiment with high efficiency.

In another mode of operation of the tandem mass spectrometer according to the present teachings, the intensity of only certain specific precursor ions and/or product ions is continuously measured. Such measurements can be acquired rapidly. In this mode of operation, it may be unnecessary or undesirable to process the ions by trapping and then ejecting the precursor ions of interest. The tandem mass spectrometer 100 can be operated without trapping by transmitting the precursor ions to be fragmented through the ion trap 102. Instead, the ion trap 102 is operated in an RF/DC resolving mode, stepping from one selected precursor to another selected precursor in a desired sequence and then acquiring MSMS spectra.

For example, the ion trap 102 can be operated as a mass filter and step through a selected mass range with a small step size of 1 amu, acquiring MSMS spectra on each precursor ion in this transmission mode. For example, the rate of acquiring MSMS spectra can be on order of one MSMS spectrum every 10 ms, or even one MSMS spectrum every 5 ms. This mode of operation results in more rapid analysis, but with potentially less sensitivity. Also, this mode of operation does not efficiently use the samples, which makes it unsuitable for some applications.

In another mode of operation of the tandem mass spectrometer according to the present teachings, only a very narrow range of precursor ion mass-to-charge ratios are measured. In this mode of operation, the ion trap 102 is configured to be a high resolution mass selector, allowing only a very narrow range of mass-to-charge ratio values, which can be much less than 1 amu in width into the collision cell 126 for processing. For example, in one specific method, the range of precursor ion mass-to-charge ratio values is less than 0.1 amu in width. This high resolution mode can be achieved by scanning the ion trap 102 very slowly over a narrow mass range. The very slow scan can be performed over a very narrow mass range (“zoom scan”) in order to separate isobaric components in a small mass window or it may be performed over a wider mass range, which will require a longer time to complete the full scan. In this method, precursor ions of the same nominal mass but different exact mass can be separated. This method improves the signal-to-noise (S/N) in a complex sample.

One skilled in the art will appreciate that the operation of the tandem mass spectrometer according to the present teachings can easily change from a mode of operation where the ion trap 102 is a RF/DC quadrupole mass filter for precursor ion selection to modes of operation where ions are trapped and then ejected from the ion trap 102 with an axial electric field as described herein. For example, in some mass spectrometers, the modes of operation can be fully controllable with software.

### EQUIVALENTS

While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art, which may be made therein without departing from the spirit and scope of the teaching.

What is claimed is:

1. A method of processing multiple precursor ions in a tandem mass spectrometer, the method comprising:
a. generating a plurality of precursor ions with an ion source;
b. trapping at least some of the plurality of precursor ions in an ion trap;
c. isolating at least two precursor ions of interest from the plurality of precursor ions with a filtered noise field;
d. sequentially ejecting precursor ions of interest toward a collision cell;
e. fragmenting the sequentially ejected precursor ions of interest in a collision cell; and
f. determining mass-to-charge ratio spectra of the fragmented ions with a mass spectrometer.

2. The method of claim 1 wherein the isolating the precursor ions of interest comprises applying filtered noise fields with progressively narrower notches.

3. The method of claim 1 wherein the isolating precursor ions of interest comprises isolating precursor ions of interest in a linear ion trap.

4. The method of claim 1 wherein the determining the mass-to-charge ratio spectrum of the fragmented ions comprises determining the mass-to-charge ratio spectrum with at least one of a time-of-flight mass spectrometer, a quadrupole mass spectrometer, an ion trap mass spectrometer, an orbitrap mass spectrometer, and a FTMS mass spectrometer.

5. The method of claim 1 wherein the sequentially ejecting precursor ions of interest comprises sequentially ejecting the precursor ion of interest with resonance excitation.

6. The method of claim 1 further comprising identifying precursor ions in the plurality of precursor ions before isolating the precursor ions of interest.

7. A method of processing multiple precursor ions in a tandem mass spectrometer, the method comprising:
a. generating a plurality of precursor ions with an ion source;
b. trapping at least some of the plurality of precursor ions in an ion trap;
c. isolating at least two precursor ions of interest from the plurality of precursor ions with a filtered noise field;
d. ejecting first target precursor ions;
e. fragmenting the ejected first target precursor ions;
f. determining mass-to-charge ratio spectra of the fragmented first target precursor ions with a mass spectrometer;
g. ejecting second target precursor ions;
h. fragmenting the ejected second target precursor ions; and
i. determining a mass-to-charge ratio spectrum of the fragmented second target precursor ions precursor ions with a mass spectrometer.

8. The method of claim 7 wherein the isolating the at least two precursor ions of interest comprises applying filtered noise fields with progressively narrower notches.

9. The method of claim 7 further comprising identifying precursor ions in the plurality of precursor ions before isolating the precursor ions of interest.

10. A method of processing multiple precursor ions in a tandem mass spectrometer, the method comprising:
a. generating a plurality of precursor ions with an ion source;
b. trapping the plurality of precursor ions in a first ion trap;
c. transferring a portion of the plurality of precursor ions from the first ion trap to a second ion trap;
d. isolating at least two precursor ions of interest in the second ion trap with a filtered noise field;
e. sequentially ejecting the precursor ions of interest from the second ion trap;
f. fragmenting the sequentially ejected precursor ions of interest in a collision cell; and
g. determining mass-to-charge ratio spectra of the fragmented precursor ions of interest with a mass spectrometer.

11. The method of claim 10 wherein the isolating the at least two precursor ions of interest in the ion trap with the filtered noise field comprises applying progressively narrower width notches.

12. The method of claim 10 wherein the sequentially ejecting the precursor ions of interest from the ion trap comprises sequentially ejecting the precursor ions of interest with resonance excitation.

13. The method of claim 10 wherein the determining the mass-to-charge ratio spectrum of the fragmented precursor ions of interest with the mass spectrometer comprises determining the mass-to-charge ratio spectrum with at least one of a time-of-flight mass spectrometer, a quadrupole mass spectrometer, and a Qtrap mass spectrometer.

14. The method of claim 10 further comprising identifying at least some of the plurality of precursor ions before trapping the plurality of precursor ions of the collision cell.

15. The method of claim 10 further comprising repeating the steps of transferring a portion of the plurality of precursor ions from the second ion trap to the first ion trap and isolating the precursor ions of interest in the ion trap with the filtered noise field a one or more times.

16. The method of claim 15 wherein the second ion trap comprises the collision cell.

17. A method of processing multiple precursor ions in a tandem mass spectrometer, the method comprising:
a. generating a plurality of precursor ions with an ion source;
b. trapping the plurality of precursor ions in a first ion trap;
c. ejecting precursor ions of interest from the first ion trap;
d. trapping the ejected precursor ions of interest with a second ion trap;
e. sequentially ejecting the precursor ions of interest from the second ion trap;
f. fragmenting the precursor ions of interest ejected from the second ion trap; and
g. determining a mass-to-charge ratio spectrum of the ejected fragmented precursor ions of interest with a mass spectrometer.

18. The method of claim 17 wherein the ejecting the precursor ions of interest from at least one of the first and the second ion trap comprises ejecting the precursor ion of interest with resonance excitation.

19. The method of claim 17 wherein the determining the mass-to-charge ratio spectrum of the sequentially ejected fragmented precursor ions of interest with the mass spectrometer comprises determining the mass-to-charge ratio spectrum with at least one of a time-of-flight mass spectrometer, a quadrupole mass spectrometer, and a Qtrap mass spectrometer.

20. The method of claim 17 further comprising isolating the precursor ions of interest within the second ion trap with a filtered noise field before sequentially ejecting the precursor ions of interest from the second ion trap.

21. The method of claim 17 wherein the processing multiple precursor ions of interest in the ion trap comprises applying a filtered noise field with progressively narrower width notches.

22. A method of processing multiple precursor ions in a tandem mass spectrometer, the method comprising:
a. generating a plurality of precursor ions with an ion source;
b. applying a filtered noise field to an ion trap;
c. passing the plurality of precursor ions through the ion trap with the filtered noise field;
d. trapping the plurality of precursor ions from the ion trap in a second ion trap;
e. transferring a portion of the plurality of precursor ions in the second ion trap back to the first ion trap;
f. sequentially ejecting precursor ion of interest from the ion trap according to their mass-to-charge ratio;
g. fragmenting the sequentially ejected precursor ion of interest in the collision cell; and
h. determining a mass-to-charge ratio spectrum of the sequentially ejected precursor ions of interest with a mass spectrometer.

23. The method of claim 22 wherein the determining the mass-to-charge ratio spectrum of the sequentially ejected precursor ions of interest with the mass spectrometer comprises determining the mass-to-charge ratio spectrum with at least one of a time-of-flight mass spectrometer, a quadrupole mass spectrometer, and a Qtrap mass spectrometer.

24. The method of claim 22 further comprising isolating precursor ions in the ion trap with a filtered noise field.

25. The method of claim 24 wherein the isolating precursor ions in the ion trap with the filtered noise field comprises applying a filtered noise field with progressively narrower notches.

26. A method of processing multiple precursor ions in a tandem mass spectrometer, the method comprising:
a. generating a plurality of precursor ions with an ion source;
b. trapping at least some of the plurality of precursor ions in a first ion trap;
c. ejecting at least some of the plurality of precursor ions into a second ion trap;
d. trapping the ions in a second ion trap;
e. sequentially ejecting target precursor ions from the second ion trap into a collision cell;
f. fragmenting the sequentially ejected target precursor ions; and
g. determining mass-to-charge ratio spectra of the fragmented target precursor ions with a mass spectrometer;

27. The method of claim 26 further comprising isolating target precursor ions in the second ion trap with a filtered noise field.

28. The method of claim 27 further comprising applying a filtered noise field with progressively narrower width notches.
